(19) United States
(12) Patent Application Publication
(10) Pub. No.: US 2008/0158883 A1
(43) Pub. Date: Jul. 3, 2008

(54) Lighting system capable of automatically adjusting illlumination

(75) Inventors: Chien-Jung Wu, Taipei Hsien (TW); Tsung-Ting Sun, Taipei Hsien (TW); Hung-Ta Liao, Taipei Hsien (TW); Tzu-Hsuan Yen, Taipei Hsien (TW); Pao-Shen Chen, Taipei Hsien (TW)

Correspondence Address: BIRCH STEWART KOLASCH & BIRCH, PO BOX 747, FALLS CHURCH, VA, 22040-0747, US

(73) Assignee: EDISON OPTO CORPORATION

(21) Appl. No.: 11/723,918

(22) Filed: Mar. 22, 2007

(30) Foreign Application Priority Data
Dec. 29, 2006 (TW) 95150062

(51) Int. Cl. F21V 7/00

(52) U.S. Cl. 362/247

(57) ABSTRACT

A lighting system automatically adjusts at least one control illumination value of at least one illumination light beam provided to at least one selected region. The lighting system comprises at least one light assembly, a reflection element, at least one illumination sensing unit, and a control module. The light assembly comprises a plurality of light sources and a lighting direction control mechanism. After the light source projects an injection light along an injection direction, the reflection element reflects the injection light to project the illumination light toward the selected region, the illumination sensing unit senses a total illumination of the selected region to accordingly send an illumination sensing signal, the control module outputs an illumination control signal in accordance with the illumination sensing signal to control the lighting direction control mechanism to change the direction of the light assembly, therefore the control illumination can be automatically adjusted.

### FIELD OF THE INVENTION

The present invention relates to a lighting system, and more particularly to a lighting system being capable of automatically adjusting illumination.

### BACKGROUND OF THE INVENTION

For indoor illumination-design, a lighting device providing different illumination variations is adopted for the changing environment caused by the alternation of day and night and the variations of weather.

Meanwhile, in some specified application fields, such as the animal and plant cultivation, the illumination control is then the most important factor. For example, in the north hemisphere of the earth, the illumination-hour of sunshine is less than 12 hours form the Autumnal Equinox to the Spring Equinox of next year, so that for getting better efficiency of cultivation, it is necessary to provide additional illumination hours to the cultivated animals or plants by the specified lighting devices.

For indoor or outdoor sport stadiums, the illumination value of environment is obviously varied due to some activities and sport games are played from day to night. For the purpose of making the players enjoy the activities or sport games without being influenced by the variations of environment illumination, it is usually necessary to use proper lighting systems or devices for providing stable illumination under the variations of environment.

For meeting the requirements as mentioned above, an embodiment of illumination adjustment technique provided according to prior arts is cited as follows. Please refer to FIG. 1, which illustrates a partial view of a lighting system provided in prior arts. As shown in FIG. 1, a lighting system 1 includes a light box 11, a light assembly 12, a reflection assembly 13, and a control element 14. The light is disposed at a specified position within the light box 11 and has a plurality of light sources 121. The reflection assembly 13 includes a reflection plate 131 and a lighting direction control mechanism 132. The lighting direction control mechanism 132 is connected to the light box 11 and the reflection plate 131, and mechanically or electrically connected to the control element 14.

When the lighting system 1 provides illumination to a selected region 2, the plurality of light sources 121 projects an injection light beam IL₀ along an injection direction I₀ to the reflection plate 131, the light beam IL₀ is reflected to project an illumination light beam LL₀ along an illumination direction I₁ to the surface of the selected region 2 in an injection angle θ₀.

If a user feels that the illumination light beam cannot provide sufficient illumination to the selected region 2, he can operate the control element 14 to control the lighting direction control mechanism 132 to make the reflection plate 131 rotate a rotation angle Δθ₀ along a rotation direction I₂. After that, the injection light beam IL₀ will be reflected again to project the illumination light LL₀ along another illumination direction I₁′ to the surface of the selected region 2 in another injection angle θ₀′. From the geographical relation shown in FIG. 1, we can easily realize that:

θ₀′=θ₀−2Δθ₀.

People skilled in related arts can easily realize the illumination value that the illumination light beam LL₀ provides to the surface of the selected region 2 can be generally calculated from the formula as follow:

I_{eff}=(Iₜₒ₁)(cos θ), wherein
I_{eff} is an effective illumination value that the illumination light beam LL₀ provides to the surface of the selected region 2;
θ is an injection angle that the illumination light beam LL₀ projects to the surface of the selected region; and
Iₜₒ₁ is a full illumination value, i.e., a maximum illumination value when the injection angle equals to 0 degree.
   As above conditions, the effective illumination value is changed from (Iₜₒ₁)·(cos θ₀) to (Iₜₒ₁)·(cos θ₀′). Due to θ₀′=θ₀−2Δθ₀, the effective illumination value that the illumination light beam LL₀ provides to the surface of the selected region 2 will be increased after above adjustment.

On the contrary, when the user feels that the illumination light beam is too bright to light on the selected region, he can operate the control element 14 to control the lighting direction control mechanism 132 to make the reflection plate 131 rotate along a rotation direction opposite to the rotation direction I₂, and then the effective illumination value that the illumination light beam LL₀ provides to the surface of the selected region 2 will be decreased.

However, as above disclosure, when carrying out the adjustment of the illumination, it is still necessary to observe the illumination of the selected region by the naked eyes of user or by an illumination sensor, and adjust the illumination value, that the illumination light beam LL0 provides to the surface of the selected region 2 through operating the control element 14, by the user. Besides, in the lighting system 1, it is only able to adjust the illumination with respect to a single selected region 2 via the reflection element 131 and the lighting direction control mechanism 132.

### SUMMARY OF THE INVENTION

The problems intend being solved in the present invention and the objects of the present invention are described as follows:

Summarizing above description, the adjustment technique of prior arts is very inconvenient to execute the adjustment of illumination due to it still needs to be carried out through that the user must observe the illumination and operate the control element. Furthermore, the adjustment technique of prior arts is only capable of adjusting the illumination with respect to a single selected region, so that the whole performance of the illumination adjustment is obviously limited.

Thus, the primary object of the present invention provides a lighting system capable of automatically adjusting illumination. The lighting system senses an integral illumination value of a selected region via an illumination sensing unit, and automatically adjusts an injection angle of an illumination light beam projected from a plurality of light sources of a light assembly according to the integral illumination value sensed by the illumination sensing unit, so that a control illumination value that the illumination light beam provides to a selected region can be automatically adjusted.

The secondary object of the present invention provides a lighting system capable of automatically adjusting illumination. The lighting system is further provided with a plurality of illumination sensing units and light assemblies, so that the lighting system can sense a plurality of integral illumination values of the selected regions, so that it is capable of respectively sensing the plurality of integral illumination values of the selected regions and adjusting the control illumination values that the illumination light beams provide to the of the selected regions.

### MEANS OF THE PRESENT INVENTION FOR SOLVING PROBLEMS

Means of the present invention for solving the problems as mentioned above provide a lighting system capable of automatically adjusting at least one control illumination value that at least one illumination provides to at least one selected region. The lighting system comprises at least one light assembly, a reflection element, at least one illumination sensing unit, and a control module. The light assembly includes a plurality of light sources and a lighting direction control mechanism. After the light sources project an injection light beam along an injection direction to the reflection element, an illumination light beam is then projected to the selected region. Continuously, the illumination sensing unit can sense an integral illumination value to accordingly output an illumination sensing signal. Finally, the control module can output an illumination control signal according to the illumination sensing signal to control the lighting direction control mechanism for adjusting the control illumination value.

Meanwhile, the present invention is able to connect a data input device to the control module via a transmission cable or a wireless signal sending and receiving method. Thus, it is capable of presetting and storing at least one illumination calculation program and lighting-hour sequence according to real requirements, so that it is able to automatically adjust the control illumination value for a long period. Of course, the present invention is capable of connecting to the control element as disclosed in the prior arts, so that when the illumination sensing unit or the control module is out of order, it is still able to adjust the control illumination value that the lighting system provides to the selected region.

### EFFECTS OF THE PRESENT INVENTION WITH RESPECT TO PRIOR ARTS

Compare the lighting system of the present invention with the prior arts, the lighting system of the present invention is not only able to automatically adjust the control illumination value that the lighting system provides to a single selected region, but also automatically adjust the illumination values that the lighting system respectively provides to a plurality of selected regions. Thus, the present invention not only greatly improves the convenience of operation, but also provides an additionally function of providing different illumination values to different selected regions respectively.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates a partial view of a lighting system provided in prior arts;

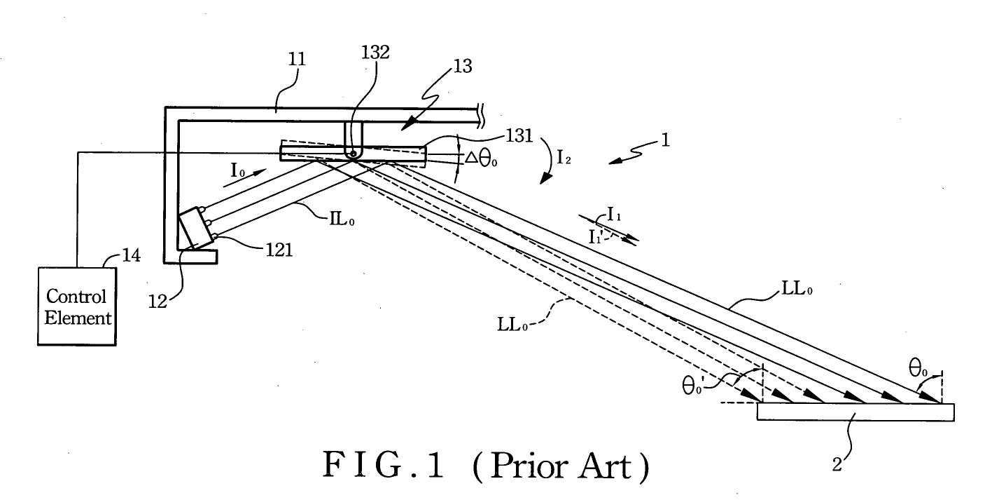

FIG. 2 illustrates a partial view of a preferred embodiment of the present invention; and

FIG. 3 illustrates a functional block diagram of a preferred embodiment of the present invention.

### DETAILED DESCRIPTION OF THE PREFERRED EMBODIMENTS

Due to that the lighting system as provided in accordance with the present invention can be widely applied to many illumination applications, the combined applications are too numerous to be enumerated and described so that we disclose two preferred embodiments here.

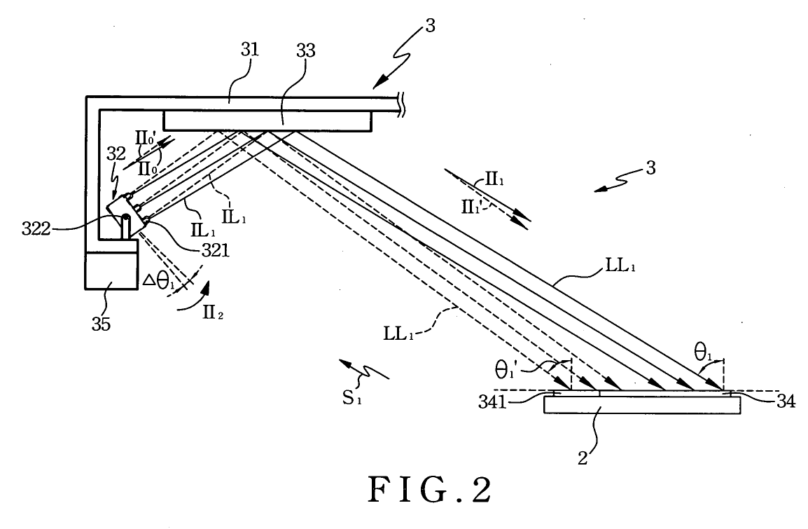

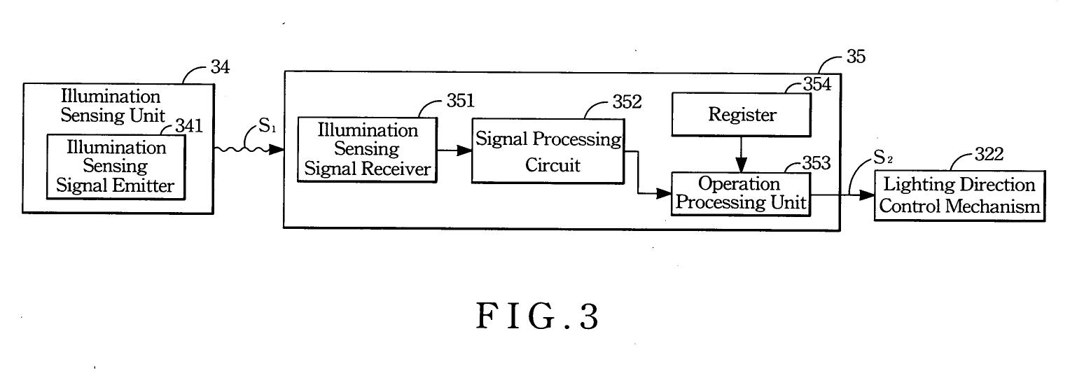

Please refer to FIG. 2 and FIG. 3, wherein FIG. 2 presents a partial view of a preferred embodiment of the present invention, and FIG. 3 presents a functional block diagram of a preferred embodiment of the present invention. As shown in the figures, a lighting system 3 includes a light box 31, a light assembly 32, a reflection element 33, an illumination sensing unit 34, and a control module 35.

The light assembly 32 is disposed in a specified position within the light box 31, and has a plurality of light sources 321 and a lighting direction control mechanism 322. In this preferred embodiment, the light sources can be light emitting diodes (LEDs), and the lighting direction control mechanism 322 is connected to the light box 31 and mechanically or electrically connected to the control module 35. The illumination sensing unit 34 is arranged in the selected region 2, and has an illumination sensing signal emitter 341. Meanwhile, the selected region 2 has an environment illumination value before the lighting system provides illumination to the selected region.

The control module 35 includes an illumination sensing signal receiver 351, a signal processing circuit 352, an operation processing unit, and a register 354 as shown in FIG. 3. The register 354 is pre-stored an illumination calculation program, and capable of presetting or pre-storing at least one lighting-hour sequence in accordance with real requirements.

When the lighting system 3 provides illumination to the selected region, the lighting sources 321 project an injection light beam IL₁ along the injection direction II₀ to the reflection element 33, after that, an illumination light beam LL₁ is projected along an illumination direction II₁ to the surface of the selected region 2 in an injection angle θ₁, for providing a control illumination value to the selected region 2.

Meantime, the illumination sensing unit 34 arranged in the selected region 2 can automatically sense an integral illumination, which equals to the sum of the environment illumination value and the control illumination value. When the control illumination value equals to zero, the lighting system has not provided any illumination to the selected region yet, so that the integral illumination value equals to the environment illumination value. In other words, the illumination sensing unit 34 is also capable of sensing the environment illumination value. The illumination sensing signal emitter 341 of the illumination sensing unit 34 can then output an illumination sensing signal S₁ representing the integral illumination value, and the illumination sensing signal receiver 351 of the control module 35 receives the illumination sensing signal S₁.

After that, the illumination sensing signal S₁ is filtered, amplified, and normalized by the signal processing circuit 352 and then transmitted to the operation processing unit 353. The operation processing unit 353 can download the preset or pre-stored illumination calculation program or lighting-hour sequence from the register 354 to execute an analyzing calculation to the integral illumination transmitted by the illumination sensing signal S₁, and then output an illumination control signal S₂ to the lighting direction control mechanism 322 for controlling the light assembly 32 to change directions.

If the integral illumination value is too low, the illumination control signal S₂ can control the light assembly 32 turning along a rotation direction II₂ in a rotation angle Δθ₁. After that, the light sources 321 can project the injection light beam IL₁ along another injection direction II₀′ to the reflection element 33, and then the illumination light beam LL₁ is projected along another illumination direction II₁′ to the surface of the selected region 2 in another injection angle θ1′, hereafter to carry out the adjustment of the control illumination of the lighting system 3 provided to the selected region.

From the geographical relation as shown in FIG. 2, we can realize that θ₁′=θ₁−2Δθ₁. As mentions in prior arts, the control illumination value of the light beam LL₁ provided to the surface of the selected region 2 can be generally calculated from the formula as follow:

I_{eff}=(Iₜₒ₁)(cos θ), wherein
I_{eff} is an effective control illumination value that the illumination light beam LL₁ provides to the surface of the selected region 2;
θ is an injection angle that the illumination light beam LL₁ projects to the surface of the selected region; and
Iₜₒ₁ is a full control illumination value, i.e., Iₜₒ₁ is a maximum control illumination value when the injection angle equals to 0 degree.
   Under the conditions of the preferred embodiment, the effective illumination value is changed from (Iₜₒ₁)·(cos θ₁) to (Iₜₒ₁)·(cos θ₁′). Due to θ₁′=θ₁−2Δθ₁, the effective control illumination value that the illumination light beam LL₁ provides to the surface of the selected region 2 will be increased after above adjustment.

On the contrary, when the integral illumination value is too high, the illumination control signal S₂ can turn the lighting direction control mechanism 322 along a rotation direction opposite to the rotation direction II₂, and then the effective control illumination value, that the illumination light beam LL₁ provides to the surface of the selected region 2, will be decreased.

People skilled in related arts can easily realize that, the adjustment of the control illumination of the preferred embodiment is executed by adjusting the injection angle θ₁, while in practice, installing proper voltage dividing circuits or voltage control chips in the light assembly 32 can adjust the voltage supplied to the light sources 321. Through the means, the strength of the injection light beam IL₁ projected from the light sources 321 can be adjusted, moreover, the control illumination value, that the illumination light beam LL₁ provides to the surface of the selected region 2, also can be simultaneously adjusted.

Although the lighting system 3 of the preferred embodiment only has a light assembly 32, the lighting system 3 can be still fitted with a plurality of light assemblies 32. The light assemblies can be disposed within the light box 11 according to a specified array or around the inner wall of the light box. Moreover, the embodiment can adopt another way of arranging a plurality of illumination sensing units 34 in a plurality of selected regions 2 respectively, and simultaneously controlling the light assemblies 32 turning in different rotation angles via the control module 35 in accordance with the integral illumination values sensed by the plurality of illumination sensing units 34.

Positively, it is able to provide two or more illumination light beams with a same injection angle or different angles respectively from two or more light assemblies to a single selected region for adjusting the control illumination value that intended to be provided to the single selected region.

Besides, the reflection element 33 can be formed with a pattern-grained surface for modulating the illumination light beam LL₁ to prevent that the user feels the illumination light beam LL₁ being too harsh to see. Furthermore, the reflection element 33 can be made through micro-structural design and proper surface treatment to have a performance of anti-glare. Obviously, the present invention can be connected to the control element as provided in prior arts, so that the embodiment can manually control the lighting direction control mechanism 322 when the illumination sensing unit 34 or the control module 35 is out of order.

In the lighting system 3, it is able to connect a data input device to the register 354 via a transmission cable or a wireless signal sending and receiving method in order to input the pre-set or pre-stored illumination calculation program and lighting-hour sequence.

Hereinafter, an application will be disclosed to explain above technique. When the lighting system 3 provides illumination to the long-sunshine-hour plants, a lighting-hour sequence according to the growth requirement of the long-sunshine-hour plants located in one of the selected regions can be pre-set and pre-stored, and the long-sunshine-hour plants may be located in a selected region wherein the light-hour sequence includes an integral illumination value and an illumination maintenance time.

For example, for the first three months, the long-sunshine-hour plants located in the selected region may need to be illuminated in one integral illumination value of 20 lumens for 16 hours and the other integral illumination value of 2 lumens for 8 hours per day; after three months, the long-sunshine-hour plants located in the selected region may need to be illuminated in one integral illumination of 30 lumens for 14 hours and the other integral illumination of 4 lumens for 10 hours per day.

When the long-sunshine-hour plants located in the selected region 2 need to be illuminated in the integral illumination value of 30 lumens, but the environment illumination value is only 2 lumens, the lighting system 3 should provide a control value of 28 lumens to meet the requirements of 30 illumination. Therefore, if the maximum control illumination value, that one of the light assemblies 32 provided to the selected region 2, is 20 lumens, the illumination sensing unit 34 only can sense an integral illumination value of 22 lumens, so that it still need another 8 lumens. Thus, another one of the light assemblies 32 can provide another control illumination value of 8 lumens to the long-sunshine-hour plants located in the selected region 2, after that, the whole lighting system 3 can provide the total control illumination of 28 lumens and make the integral illumination value meet the requirement of 30 lumens.

Although the present invention has been described with reference to the preferred embodiments thereof, it is apparent to those skilled in the art that a variety of modifications and changes may be made without departing from the scope of the present invention which is intend to be defined by the append claims.

What is claimed is:

1. A lighting system applied to automatically adjust at least one control illumination value, that at least one illumination light beam provides to at least one selected region, and comprising:
at least one light assembly comprising:
a plurality of light sources for projecting an injection light beam along an injection direction; and
a lighting direction control mechanism for turning the light assembly to change the injection direction;
a reflection element being disposed at the passing path of the injection light for reflecting the injection light to project the illumination light beam along an illumination direction to the selected region and providing the control illumination value;
at least one illumination sensing unit being disposed in the selected region for sensing an integral illumination value of the selected region and outputting an illumination sensing signal representing the integral illumination value; and
a control module for outputting an illumination control signal according to the illumination sensing signal to control the lighting direction control mechanism turning to adjust the injection direction, the illumination direction, and the control illumination value.

2. The lighting system as claimed in claim 1, wherein the light sources are a plurality of light emitting diodes (LEDs).

3. The lighting system as claimed in claim 1, wherein the selected region has an environment illumination value before the illumination light beam is reflected to the selected region, and the integral illumination value equals a sum of the environment illumination value and the control illumination value.

4. The lighting system as claimed in claim 1, wherein the illumination sensing unit comprises an illumination sensing signal emitter for outputting the illumination sensing signal.

5. The lighting system as claimed in claim 4, wherein the control module comprises an illumination sensing signal receiver for receiving the illumination sensing signal.

6. The lighting system as claimed in claim 1, further pre-stored with an illumination calculation program.

7. The lighting system as claimed in claim 6, wherein the control module further comprises an operation processing unit for calculating the control illumination value according to the integral illumination value via the illumination calculation program to accordingly output the illumination control signal.

8. The lighting system as claimed in claim 1, wherein the reflection element is formed with a pattern-grained surface for modulating the illumination light beam.

9. The lighting system as claimed in claim 1, wherein the reflection element is formed with a structure of anti-glare to prevent the illumination light beam having a light-flare property.
